(19) United States
(12) Patent Application Publication
(10) Pub. No.: US 2009/0228321 A1
(43) Pub. Date: Sep. 10, 2009

(54) Accessing an Enterprise Calendar and Scheduling Group Meetings Using a Mobile Device

(75) Inventors: Suresh Srinivasan, Bangalore (IN); Rohit Koul, Bangalore (IN); Varun Khurana, Bangalore (IN); Rakesh Komuravelli, Hyderabad (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 12/106,354

(22) Filed: Apr. 21, 2008

(30) Foreign Application Priority Data
Mar. 4, 2008 (IN) 540/CHE/2008

(51) Int. Cl. G06F 9/46

(52) U.S. Cl. 705/9

(57) ABSTRACT

A method of scheduling a group meeting wherein, the request for the group meeting is received as a message from a mobile device. The received message identifies the group. The group comprises of a plurality of members and information on the group and its members is pre-defined and stored in a repository. Availability of the members of the group for the requested group meeting is determined from a calendar system and accordingly a schedule for the group meeting is created. A message is sent to all the members of the group providing information on the scheduled group meeting.

### RELATED APPLICATION

The present application is related to and claims priority from the co-pending India Patent Application entitled, “Accessing an Enterprise Calendar and Scheduling Group Meetings Using a Mobile Device”, Serial Number: 540/CHE/2008, attorney docket number: ORCL-068/India, Filed: Mar. 04, 2008, Applicant: Oracle International Corporation, naming the same inventors Suresh Srinivasan, Rohit Koul, Varun Khurana and Rakesh Komuravelli as in the subject patent application, and is incorporated in its entirety herewith.

### BACKGROUND

Technical Field

The present invention generally relates to an enterprise calendar system, and more specifically to accessing the enterprise calendar and scheduling group meetings using a mobile device.

### BRIEF DESCRIPTION OF THE DRAWINGS

Embodiments of the present invention will be described with reference to the accompanying drawings briefly described below.

FIG. 1 is an illustrative snapshot of an enterprise calendar demonstrating the method of creating a group meeting using a web client as in the prior art.

FIG. 2 is a block diagram illustrating the environment in which the system operates according to an embodiment of the present invention.

FIG. 3 demonstrates a graphical user interface to define the groups according to an embodiment of the present invention.

FIGS. 4-1 to 4-6 is example group information as stored in a repository according to an embodiment of the present invention.

FIG. 5 is a flowchart illustrating the manner in which the server system operates to schedule a group meeting according to an embodiment of the present invention.

FIG. 6 is a flowchart illustrating the manner in which the server system operates to schedule a group meeting in a specific scenario according to an embodiment of the present invention.

FIG. 7 is a flowchart illustrating the role of the enterprise calendar system to schedule the group meeting according to an embodiment of the present invention.

FIG. 8 is a table illustrating a list of pre-defined message formats acceptable at the server system according to an embodiment of the present invention.

FIG. 9 is a block diagram illustrating the details of digital processing system in which several aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

1. Overview

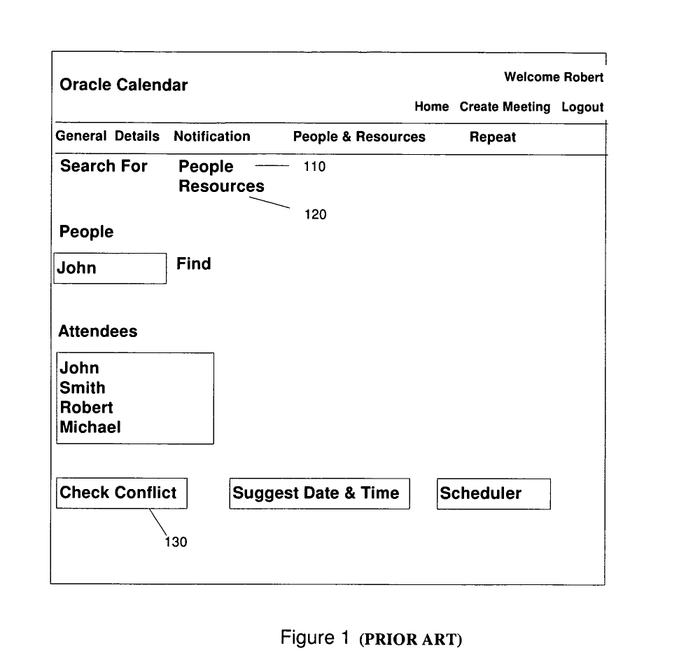

There are various enterprise calendar products that allow for scheduling of people, resources and events in the enterprise in addition to management of personal calendar such as cancel meetings, view the daily or weekly agenda, set reminders, etc. Scheduling a group meeting such as meeting between two or more users of the enterprise calendar usually requires a meeting requester to select for each meeting, the list of invitees required for the meeting and various resources such as meeting rooms, video conferencing equipments, etc. Most enterprise calendars offer users one or more interfaces to interact with the calendar such as a web client, a desktop client or the ability to manage the calendar using a handheld device such as a PDA by synchronizing the enterprise calendar data such as meetings, daily notes, day events, etc with the handheld device. In order to create a group meeting a user typically browses the calendar application as shown in FIG. 1 for a web client interface. The user selects the meeting invitees 110 and resources 120 such as meeting room, etc and selects a time and date for the meeting, checks for conflicts 130 and sets the meeting. Subsequently an email is sent to all the invitees who then accept or reject the meeting and accordingly the calendar of the meeting requester and the meeting invitees are updated with the meeting information.

Information relevant to accessing the enterprise calendar and scheduling group meetings using a mobile device can be found in U.S. Pat. No. 6,370,566, U.S. Pat. No. 6,75,530 and US Patent Application 20060212330. However, each one of these references suffers from one or more of the following disadvantages. For example, in U.S. Pat. No. 6,370,566 special applications are required to be installed on the mobile device and additional processing is required on the part of the mobile device. Similarly, in U.S. Pat. No. 6,75,530 one of the disadvantages is that an additional version of the calendar application suited for the mobile device has to be designed. In U.S. Patent Application 20060212330 a calendar application is locally stored on the mobile device and the user selects each one of the meeting invitees and other details for the meeting using the local calendar application. This is an added requirement on the memory and processing capacity of the mobile device.

According to some embodiments of the present invention an enterprise user is enabled with access to the enterprise calendar and the ability to schedule group meetings from the user's mobile device. An enterprise user or a meeting requester interested in scheduling a group meeting can send a request for the group meeting from his mobile device by sending a message such as a text message from a list of pre-defined messages to a server system capable of receiving text messages. The content of the message indicates the required people (list of invitees) and resources in the form of a group identifier or group ID and indicates the proposed date and time for the group meeting. The group ID is pre-defined by an enterprise user and stored in the server repository and includes information on all the members of the group and on the resources required for the group meeting such as preferred room, etc. The server upon receiving the meeting request authenticates the meeting requester and identifies from its repository the members of the group and resources required for the proposed group meeting. The server then automatically sends a request to the enterprise calendar system to check for the availability of the members of the group and the resources required for the group meeting. Based on the response received from the enterprise calendar system the server creates a schedule for the group meeting. A message such as a text message from the list of pre-defined messages is sent from the server to the mobile devices of each of the members of the group, providing information on the scheduled group meeting.

According to another embodiment the request to the server system for the group meeting can be a voice message from the user and speech-to-text conversion can be done at the server system using either hardware or software or a combination thereof. Or in yet another embodiment the speech-to text-conversion can be done at the user's mobile device using either hardware or software or a combination thereof.

According to another embodiment of the present invention, to create a schedule for the group meeting the server system sends the group meeting information to the enterprise calendar system that in turn checks for the availability of the people and resources as indicated in the group meeting information. The enterprise calendar system responds to the server system indicating either the availability of all the required people and resources or indicating a conflict in the schedule. In an example embodiment in case of a conflict the enterprise calendar system based on its internal conflict resolution mechanism may suggest the server system alternative schedules for the proposed group meeting.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

2. Example Environment

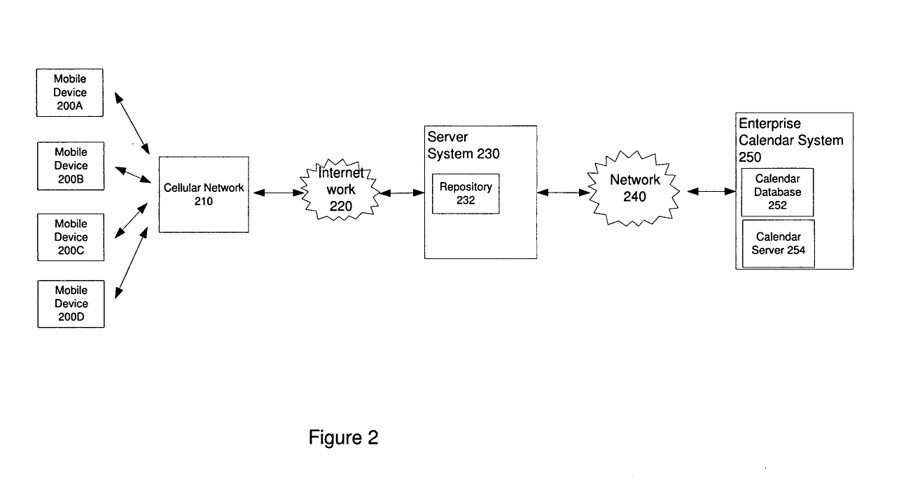

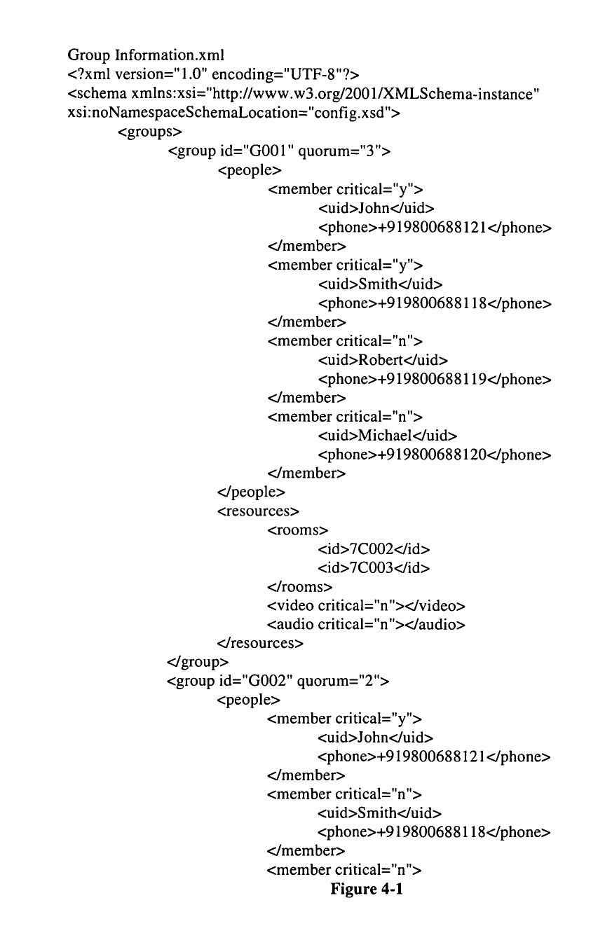

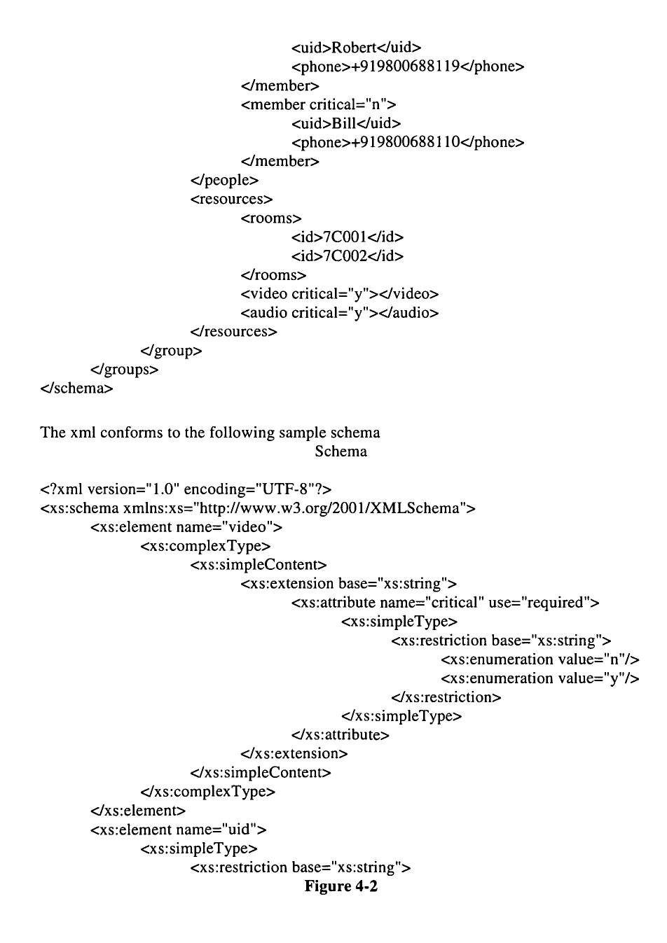

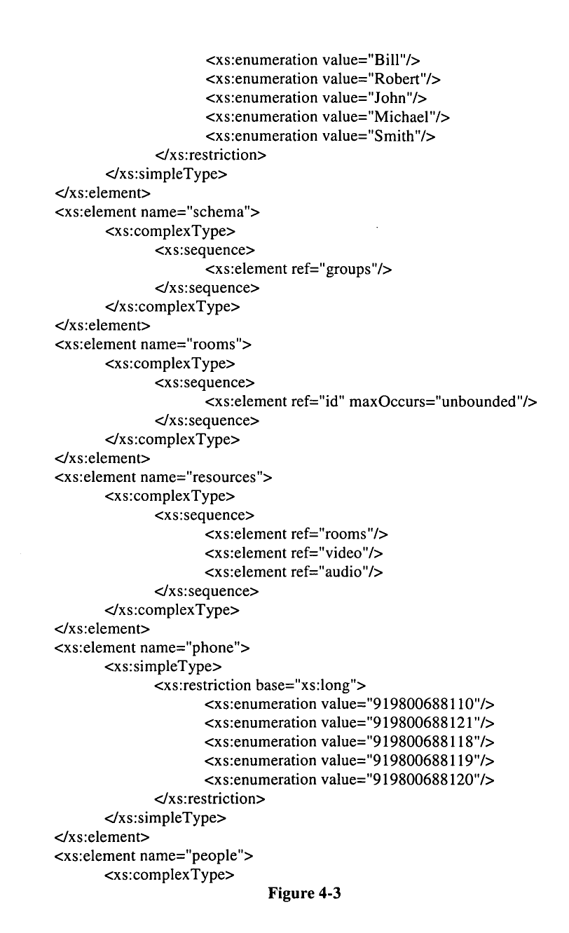

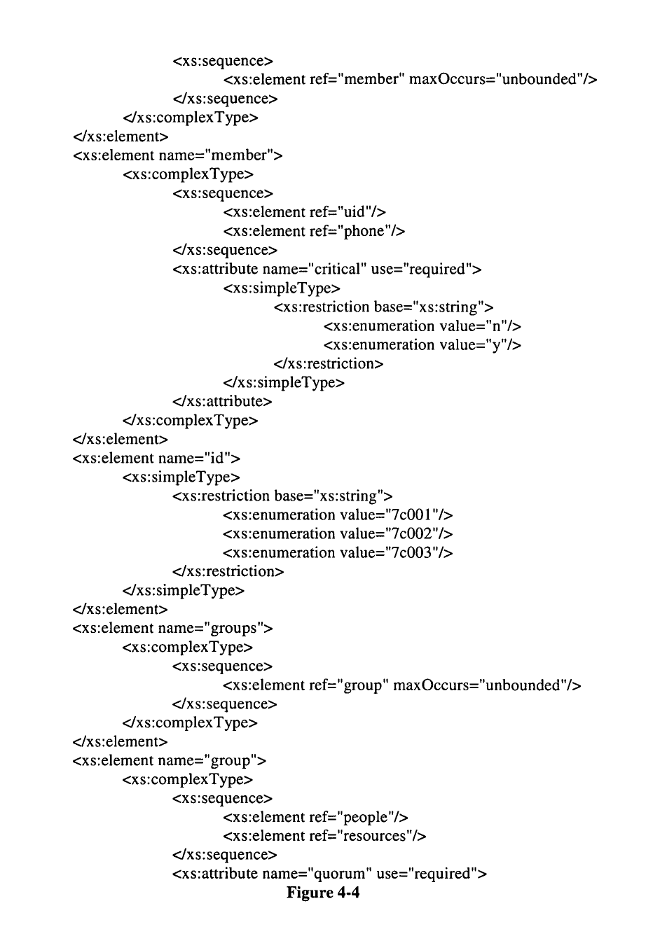

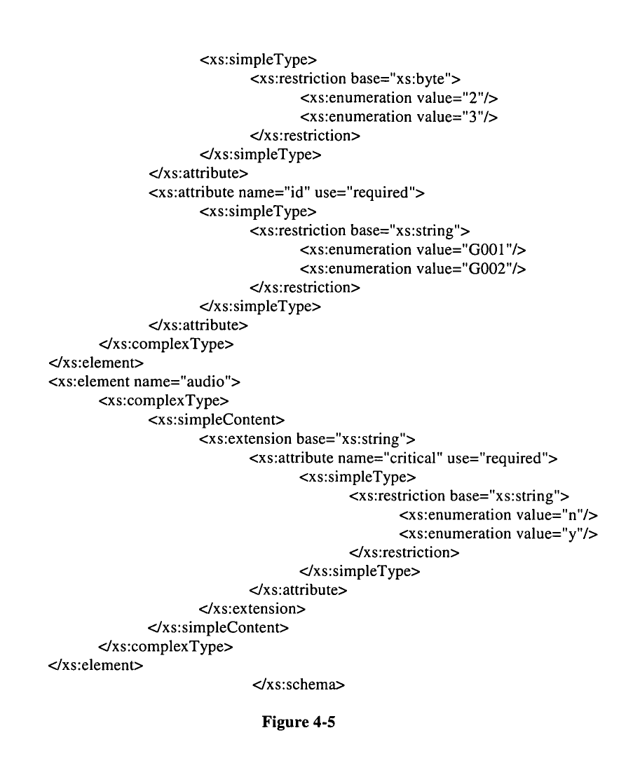

Some or all of the Figures below have been explained with reference to an example when required. Various preferred embodiments of the present invention have been described below with reference to FIGS. 2 to 8.

FIG. 2 is a block diagram illustrating an example environment in which several aspects of the present invention can be implemented. The diagram is shown containing mobile devices 200A-D, cellular network 210, Internetwork 220, a server system 230, repository 232, network 240, enterprise calendar system 250, calendar database 252 and calendar server 254.

The mobile devices 200A-D are individually capable of wireless uplink and downlink communication with a cellular network 210 and at the minimum facilitate communication via text messages, in addition to, the standard voice communication. An example for the mobile devices 200A-D is a conventional cell phone device such as those available from Motorola or Nokia Corporation.

The cellular network 210 is a radio network that provides wireless services including voice communication and messaging services such as the short messaging service (SMS) to its subscribers. Short Message Service (SMS) is a communications protocol allowing the interchange of short messages between mobile telephony devices, as is well known in the art. The cellular network 210 is interoperable with a server system 230 over an Internetwork 220 by way of a gateway (not shown here) as is well known in the relevant art. Typical examples of cellular network 210 and the corresponding service providers are the GSM (Global System for Mobile Communications) network from AT&T and the CDMA-based (Code Division Multiple Access) network from Verizon Wireless, USA.

The Internetwork 220 provides connectivity between the server system 230 and the cellular network 210 and may be implemented using protocols such as the Internet Protocol (IP) well known in the relevant art.

The server system 230 is capable of receiving text messages from the mobile devices 200A-D, performing required actions based on the received message and sending text messages to the mobile devices 200A-D. The server system 230 includes a repository 232 that stores information relevant to each group and information on scheduled meetings. According to some of the embodiments of the present invention the repository 232 may be a flat file, a simple XML or a database. The server system 230 is interoperable with an enterprise calendar system 250 via network 240.

The network 240 provides connectivity between the server system 230 and the enterprise calendar system 250 and may be an intra network or inter network and may be implemented using protocols such as the Internet Protocol (IP) well known in the relevant art.

An example of the enterprise calendar system 250 is the Oracle® Calendar from Oracle Corporation of Redwood Shores, Calif. The enterprise calendar system 250 comprises a calendar database 252 and a calendar server 254. The calendar server 254 at the minimum enables management of user calendars, scheduling of events and resources and is interoperable with the server system 230. The calendar database 252 stores global information on each user of the enterprise such as a global user ID (UID), each enterprise user's calendar, information on resources and scheduled events and other necessary information to perform the scheduling operation. It may be appreciated that the calendar database 252 may in part be separate from the enterprise calendar system 250. For instance the global information such as the UID may be stored in a directory external to the enterprise calendar system 250.

For illustration a representative number and type of systems and components have been shown in FIG. 2. However, the invention can be extended to other environments operating with more number of systems and components and to environments with different types of components wherein such an invention may be operated. For example, the mobile device can also be a part of wireless networks other than a cellular network; an example of such an environment may be a handheld or PDA device wirelessly interoperable with server system 230 over a local area network, with suitable intermediate components.

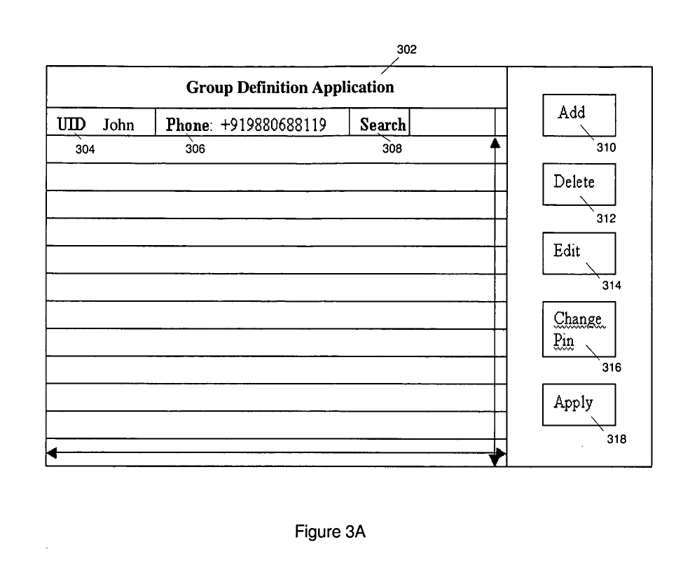

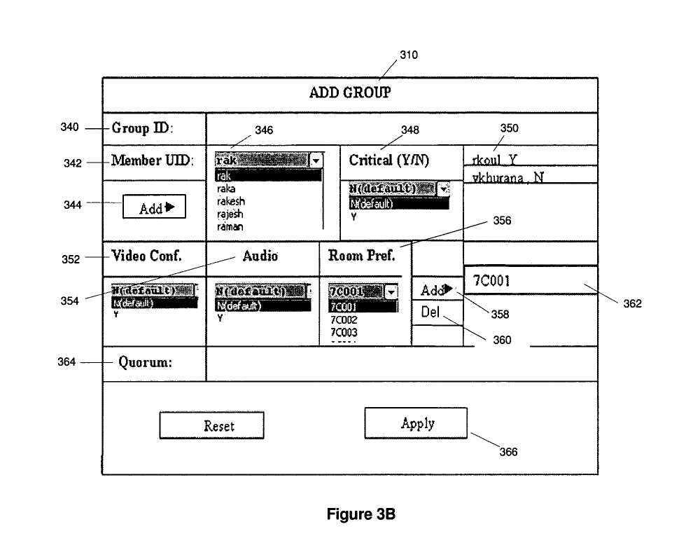

According to an embodiment of the present invention, an enterprise user can define one or more groups for meeting wherein each group comprises of two or more members from the list of enterprise users having a UID that is stored in the calendar database 252. Defining a group for meeting involves creating a group ID, selecting two or more members for the group ID and configuring one or more attributes for each member of the group ID where the attributes specify, for example, whether a member is a critical member of the group without whom the meeting for that group may be declined. The group definition also involves configuring the resources for the group such as preferred meeting room location. FIGS. 3A and 3B demonstrate a sample graphical user interface (GUI) using which an enterprise user can define groups and configure the relevant attributes and resources for each group. This subsequently populates the repository 232 in the server system 230.

Using the group definition application 302 of FIG. 3A an enterprise user 304 can enter a phone number 306 such as a mobile phone number that the enterprise user 304 will use to send messages to the server system 230. The phone number 306 also acts as a first step of authentication of the enterprise user 304 with the server system 230. Additionally, the enterprise user 304 may also choose to create a user generated personal identification number (PIN) 316 as a second step of authentication with the server system 230. The enterprise user 304 can create a new group using the ADD button 310.

FIG. 3B shows the UI that appears when the ADD button 310 is selected. The user 304 can enter a Group ID 340 that may comprise alphanumeric characters. The Add button 344 allows to select members for the group ID 340 using the UID 342 as listed in the pull-down menu/list 346. The UID's 346 are based on the global user ID stored in the calendar database 252. Each member UID 346 added to the group ID 340 can be configured as a critical resource using the pull-down menu 348, selecting a Y (Yes) for a critical resource and N (NO) for a non-critical resource. 350 provides a list of the members added to the group and the critical resource attribute set for each member. 352 and 354 allow the enterprise user 304 to configure other resources required for the group ID 340, such as videoconference and audio respectively. 356, 358 and 360 allows configuration of one or more preferred meeting rooms for the group. 362 gives a list of all the preferred meeting rooms configured for the group ID 340. 364 sets a Quorum (e.g., minimum number of attendees) required for the group ID 340 to meet. In one embodiment, a default number may be set to zero. 366 applies all the settings for the group ID 340. Similarly, in FIG. 3A, the Edit button 314 allows the enterprise user 304 to edit the configuration of an existing group, Delete button 312 deletes a group. Search 308 in FIG. 3A allows searching of resources such as available rooms, videoconference equipment, etc, searching of UID's and existing groups.

FIGS. 4-1 through 4-6 illustrate a sample group of information stored as XML files in the repository 232 of the server system 230 according to one embodiment of the invention. This information is generated as a result of the group definition in FIGS. 3A and 3B above. For example, using the group definition application of FIGS. 3A and 3B, John creates a group with an ID G001 and adds to the group Smith as a critical member, Michael and Robert as non-critical members. The group definition application of FIGS. 3A and 3B allows John to also define other information for the group ID G001 such as required rooms, resources, etc.

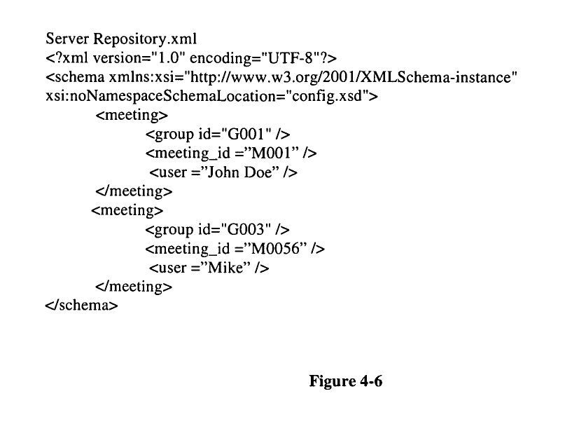

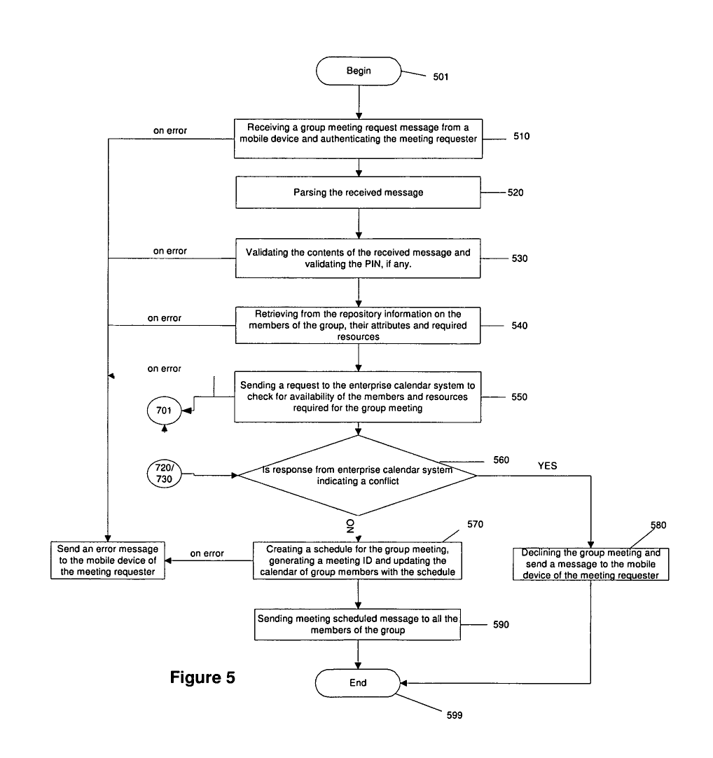

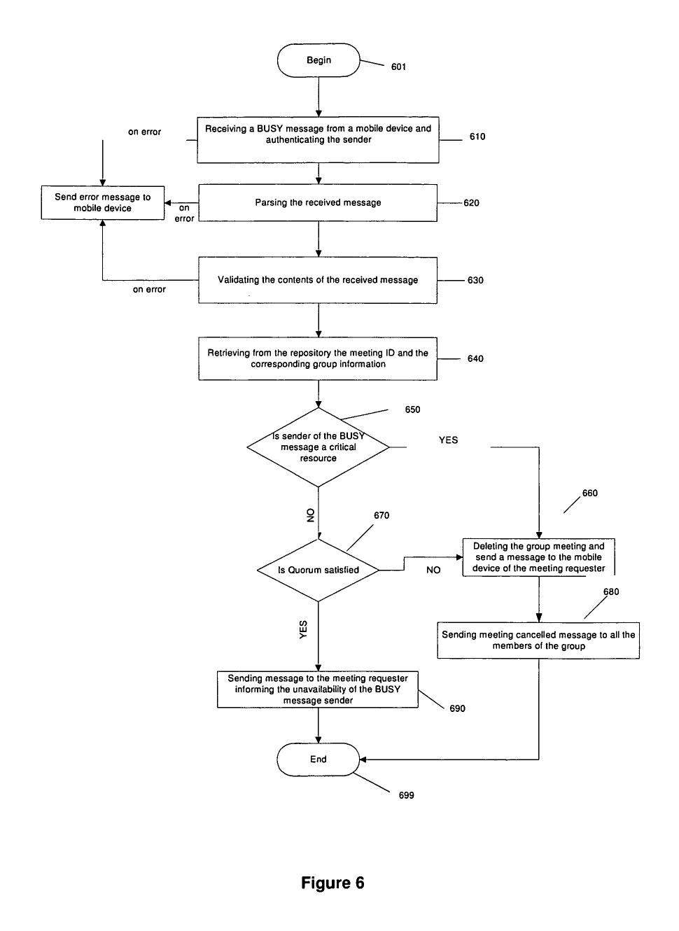

FIGS. 5 and 6 illustrate the operation of the server system 230 in scheduling a group meeting initiated from a mobile device according to an embodiment of the present invention. The operation of the server system 230 has been explained below with reference to the block diagram in FIG. 2 and the example illustrated in FIGS. 4-1 through 4-6.

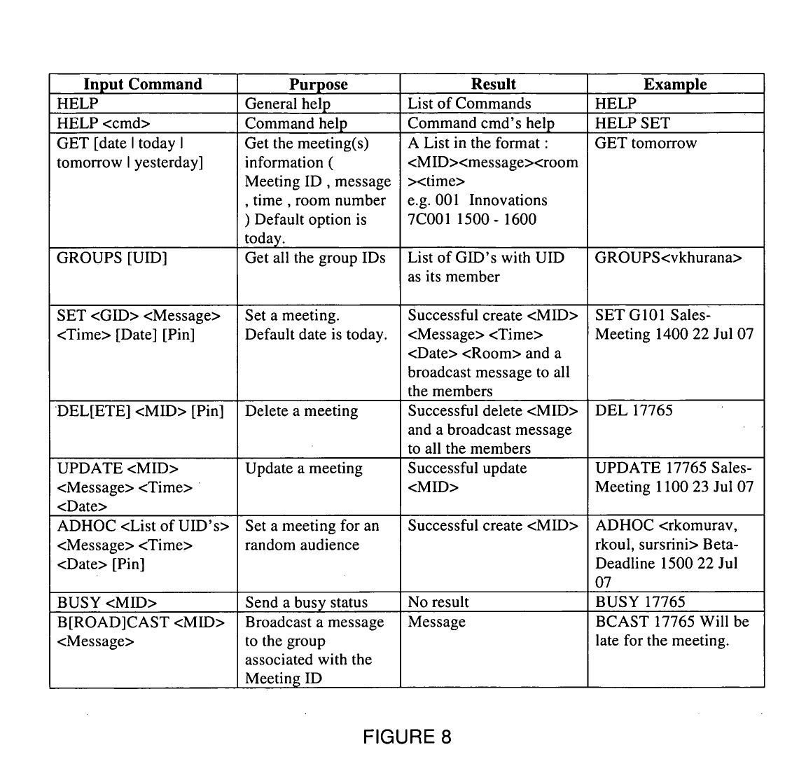

The flowcharts of FIGS. 5, 6 and 7 have been additionally explained with reference to an example where user “Robert” sends a SMS message from his mobile device 200A to server system 230 requesting a group meeting for the group ID G001, pre-defined in the repository 232 (illustrated in FIGS. 4-1 through 4-6), at 1400 hours on 1 Nov. 2007. The SMS message format is from a list of pre-defined formats stored in the server system 230. FIG. 8 provides a sample list of messages that may be sent and received to and from the server system 230. A sample meeting request message format:

SET<Group ID><Message><Time><Date>[Optional PIN]

where,

SET—command received from a mobile device to create a group meeting

Group ID—pre-defined identifier for a group

Message—Brief message indicating the purpose of the group meeting

Time—Proposed time for the group meeting

Date—Proposed date for the group meeting

Optional PIN—PIN for authentication

In the specific example, the meeting request message sent from Robert's mobile device 200A as per the pre-defined message format is:

SET G001 Review Meeting 1400 1 Nov. 2007 [12345]

The flowchart of FIG. 5 begins at step 501 when an enterprise user also termed as the meeting requester sends from his mobile device a meeting request message such as a SMS (short message service) message addressed to the server system 230. With reference to the example, the flowchart begins at step 501 when Robert sends a meeting request message from his mobile device 200A for his group G001.

In step 510 the server system 230 receives the SMS message from a mobile device and authenticates and identifies the UID of the meeting requester based on the phone number of the mobile device and the phone number stored in the repository 232 of the server system 230. In case of any error, the server system 230 sends an error message to the mobile device. In an example implementation the error message may be a standard message or a specific message indicating the type of error. With reference to the above example the server system 230 authenticates the message received from mobile device 200A and identifies the UID of the sender as Robert based on the phone number 919800688119 stored in the repository 232.

In step 520 the server system 230 parses the message received from the mobile device based on the pre-defined message format and identifies the command field, the Group ID and the PIN, if any. In case of any error the server system 230 sends an error message to the mobile device 200A. In an example implementation the error message may be a standard message or a specific message indicating the type of error. With reference to the example above the server system 230 parses the message received from the mobile device 200A and identifies that the command is a SET command and the group ID is G001.

In step 530 the server system 230 validates the PIN, in case a PIN has been included in the message received from the mobile device. This is an additional authentication based on the PIN set for the meeting requester's UID in the repository 232 of the server system 230. The server system 230 also ensures that the command is a valid command and that the Group ID is a valid ID. In case of any error the server system 230 sends an error message to the mobile device. In an example implementation the error message may be a standard message or a specific message indicating the type of error. With reference to the example the server system 230 validates the PIN 12345 against the PIN stored in the repository 232 and also validates the SET command and identifies the actions to be taken.

In step 540 the server system 230 retrieves the group information for the group ID stored in its repository 232 and identifies the UID of members of the group, the attributes and resource requirements for the group. In case of any error the server system 230 sends an error message to the mobile device. In an example implementation the error message may be a standard message or a specific message indicating the type of error. With reference to the above example, the server system 230 retrieves the following information from its repository 232 for group ID G001:

(John, Critical Member (Y)), (Smith, Critical Member (Y)), (Robert, Critical Member (N)), (Michael, Critical Member (N)), (Room 7C002, Room 7C003)

In step 550 the server system 230 sends a request to the enterprise calendar system 250 to check for availability of the people and resources for the group for which a meeting request message has been received at the server system 230. In other words, the enterprise calendar system 250 receives a request to check for the availability of the members of the group and the availability of the required resources at the proposed time. In case of any error the server system 230 sends an error message to the mobile device. In an example implementation the error message may be a standard message or a specific message indicating the type of error. With reference to the above example, the server system 230 sends a request to the enterprise calendar system 250 to check for availability of the members of the Group ID G001, namely; John, Smith, Robert and Michael at 1400 hours on 1 Nov. 2007 and availability of one of 7C002 and 7C003.

In step 560 the server system 230 receives a response from the enterprise calendar system 250. If the response received from the enterprise calendar system 250 indicates availability of all the members of the group and the required resources then the flowchart proceeds to step 570. If the response received from the enterprise calendar system 250 indicates a conflict in the availability of one or more of the members of the group and/or the resources then the flowchart proceeds to step 580.

In step 570 the server system 230 creates a schedule for the meeting, generates a meeting ID (MID), stores the MID in repository 232 and updates the enterprise calendar system 250 with the scheduled meeting, changing the calendar status of each member of the group for the scheduled time slot to a status such as “SCHEDULED”, indicating that a meeting has been scheduled for this time slot. This indicates that the time slot is not available for scheduling any other meeting for any of the members of the group. The MID may be optionally displayed for the scheduled time slot. In case of any error the server system 230 sends an error message to the mobile device. In an example implementation the error message may be a standard message or a specific message indicating the type of error. With reference to the above example a MID 17765 is generated and stored in the repository 232 and the calendars of John, Smith, Robert, and Michael are marked as “SCHEDULED” for 1400 1 Nov. 2007 for MID 17765.

In step 580 the server system 230 declines the group meeting and sends a message to the meeting requester indicating a conflict in the availability of one or more of the members of the group and/or the resources. With reference to the example, if the response from the enterprise calendar system 250 indicates that John, a critical member is not available for the meeting the server system 230 declines the meeting and sends a message to Robert on mobile device 200A.

In step 590 the server system 230 identifies the phone numbers stored in the repository 232 against the UID's of each of the members of the group and sends a meeting scheduled message to each of the members of the group in a pre-defined format:

<MID>[Group ID]<Date><Time>[Loc]<Message><Meeting Requester>

In alternate embodiment, the [Group ID] is optional and the option to send/not-send the Group ID is set by the user when he/she is configuring the settings using the GUI of FIGS. 3A and 3B.

wherein,

MID—meeting ID indicative of the scheduled meeting

Group ID—pre-defined identifier for a group [Optional]

Date—Scheduled date for the meeting

Time—Scheduled time for the meeting

Loc—Location details for the meeting [Optional]

Message—Brief message indicating the purpose of the meeting as received from the meeting requester's message in the SET command

Meeting Requester—Name of the meeting requester

With reference to the example, the server system 230 identifies from the repository 232, the phone numbers for John, Smith, Robert and Michael as 919800688121 for mobile device 200B, 919800688118 for mobile device 200A, 919800688119 for mobile device 200C and 919800688120 for mobile device 200D respectively. The server system 230 sends the below message to each of the above phone numbers:

17765 G001 1400 1 Nov. 2007 7C001 Review Meeting Robert

Flowchart ends in step 599.

FIG. 6 is a flowchart illustrating the scenario in which one or more members of the group is unavailable for the scheduled meeting. The flowchart begins at step 601 when the server system 230 receives a message from one or more members of the group indicating their unavailability for the scheduled meeting. This message is sent from the mobile device in a pre-defined format from the list in FIG. 8 as: BUSY<MID>

Where,

BUSY—command indicating that the sender of the message is not available for the meeting

MID—meeting ID identifying the meeting for which the sender of the BUSY message is not available.

With reference to the example, in a first case if John is unavailable for the scheduled meeting he sends a BUSY message from his mobile device 200B having a phone number 919800688121 to the server system 230. The message received at the server system 230 in this case is: BUSY 17765. In a second case, if Michael is unavailable for the scheduled meeting he sends a BUSY message from his mobile device 200D having a phone number 919800688120 to the server system 230. The message received at the server system 230 is: BUSY 17765.

In step 610 the server system 230 authenticates and identifies the UID of the BUSY message sender based on the phone number of the mobile device and the phone number configured in the repository 232 of the server system 230. In case of any error the server system 230 sends an error message to the mobile device. In an example implementation the error message may be a standard message or a specific message indicating the type of error. With reference to the example, in the first case the server system 230 identifies that the UID for 919800688121 is John. In the second case, the server system 230 identifies that the UID for 919800688120 is Michael.

In step 620 the server system 230 parses the message received from the mobile device based on the pre-defined message format and identifies the command field and the remaining fields. In case of any error the server system 230 sends an error message to the mobile device. In an example implementation the error message may be a standard message or a specific message indicating the type of error. With reference to the example above the server system 230 parses the message received from the mobile device and identifies that the command is a BUSY command and the MID is 17765.

In step 630 the server system 230 ensures that the command is a valid command and that the MID is a valid meeting ID. In case of any error the server system 230 sends an error message to the mobile device. In an example implementation the error message may be a standard message or a specific message indicating the type of error. With reference to the example, the server system 230 validates the BUSY command is a valid command and the MID 17765 is a valid ID stored in the repository 232.

In step 640 the server system 230 retrieves the meeting information for the MID stored in its repository 232 and identifies the Group ID and the corresponding group information for the Group ID. With reference to the example, the server system 230 identifies that for MID 17765 the group ID is G001 and also identifies the corresponding group information.

In step 650 the server system 230 identifies if the sender of the BUSY message is a critical resource, if yes, the flow chart proceeds to step 660 otherwise the flowchart proceeds to step 670. In the first example of step 601 of the flowchart when a BUSY message is received from John, the server 230 identifies that John is a critical resource for the Group ID G001 and the flowchart proceeds to step 660. In the second example of step 601 of the flowchart when a BUSY message is received from Michael, the server 230 identifies that Michael is not a critical resource for the Group ID G001 and the flowchart proceeds to step 670.

In step 660 the server system 230 deletes the MID from the repository 232, deletes the meeting from the enterprise calendar system 250 and updates the calendar of each of the members of the group, changing the calendar status of each member of the group for the scheduled time slot to a status such as “AVAILABLE” indicating the scheduled meeting is cancelled and that the time slot is now available for scheduling other meetings. With reference to the example, the scheduled meeting, MID 17765 is deleted from the calendars of John, Smith, Robert and Michael and the calendar status for each for the time slot 1400 1 Nov. 2007 is marked as “Available”.

In step 680 the server system 230 sends a message to each of the members of the group indicating that the meeting is cancelled, in a pre-defined message format: <MID><Cancelled>. With reference to the example, the message sent to John, Smith, Robert and Michael is: 17765 Cancelled. The flowchart ends in step 699.

In step 670 the server system 230 determines whether the Quorum as configured in the repository 232 for the group is satisfied. If the quorum is not satisfied the flowchart proceeds to step 660 otherwise the flowchart proceeds to step 690. With reference to the example, the server system 230 determines that quorum is satisfied.

In step 690 when all the requirements for the meeting have been successfully met the server system 230 sends a consolidated message to the meeting requester, informing that the meeting as requested is scheduled but one of the members of the group is unavailable for the meeting. With reference to the example, a message is sent to Robert indicating that the meeting is scheduled with unavailability of Michael. The flowchart ends in step 699.

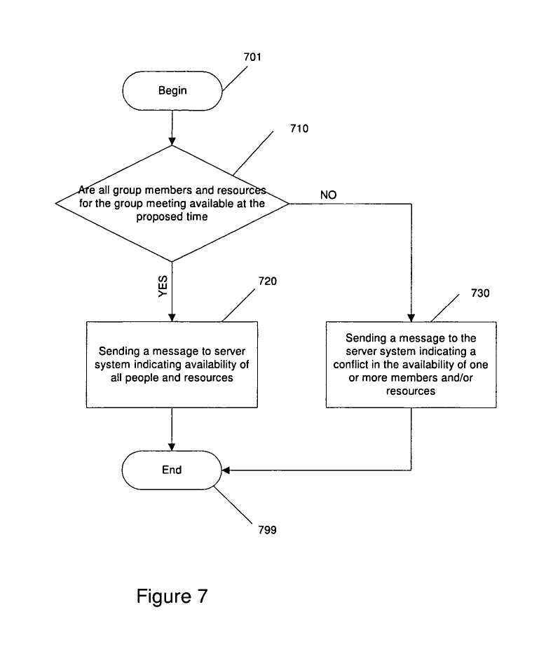

The enterprise calendar system 250 operates in a manner as is well known in the relevant art. However, for the purpose of illustration FIG. 7 shows the operation of the enterprise calendar system 250 according to an embodiment of the invention.

The flowchart begins in step 701 when the enterprise calendar system 250 receives from the server system 230 a request to check for availability of the people and resources for the group ID for which a meeting request message has been received at the server system 230. In other words, the enterprise calendar system 250 receives a request to check for the availability of the members of the group and the availability of the required resources at the proposed time. With reference to the example, wherein the server system 230 receives a meeting request for group G001 from Robert from his mobile device 200A, the enterprise calendar system 250 receives a request to check for availability of John, Smith, Robert and Michael at 1400 hours on 1 Nov. 2007 and availability of one of 7C002 and 7C003.

In step 710 the enterprise calendar system 250 checks for the availability of the people and resources at the proposed time. If all the resource requirements are satisfied the flowchart proceeds to step 720 otherwise the flowchart proceeds to step 730.

In step 720 the enterprise calendar system 250 sends a message to the server system 230 indicating that all the members and resources are available and the flowchart ends in step 799.

In step 730 the enterprise calendar system 250 sends a message to the server system 230 specifically indicating a conflict in the availability of one or more of the required members and/or resources. The flowchart ends in step 799.

The flowcharts and examples described above are one manner in which the invention may be operated and used. It may be appreciated that the invention can be extended to the user of a mobile device initiating a meeting request in a voice message that is sent to the server system 230 where the voice message may be converted to text and further processed. Also, there may be one or more ways in which the server system 230 processes the meeting request message and sends the meeting schedule message.

For example, the server system 230 may additionally send a meeting scheduled message to one or more members of the group through an alternate communication channel such as an email communication, if an email address for the member is stored in the repository 232. Further, the messages sent from the server system 230 to the mobile devices may include more intelligent information to assist the meeting requester in determining a suitable schedule for a declined meeting request. One of the many alternatives by which this may be possible involves, the enterprise calendar system 250 running an internal conflict resolution algorithm as is well known in the relevant art to determine alternative meeting schedules for the requested group meeting and sending this information to the server system 230.

It should be appreciated that the features described above can be implemented in a combination of one or more of hardware, software and firmware, as suited for the specific environment. The description is continued with respect to an embodiment in which the features are operative upon execution of appropriate software instructions.

3. Digital Processing System

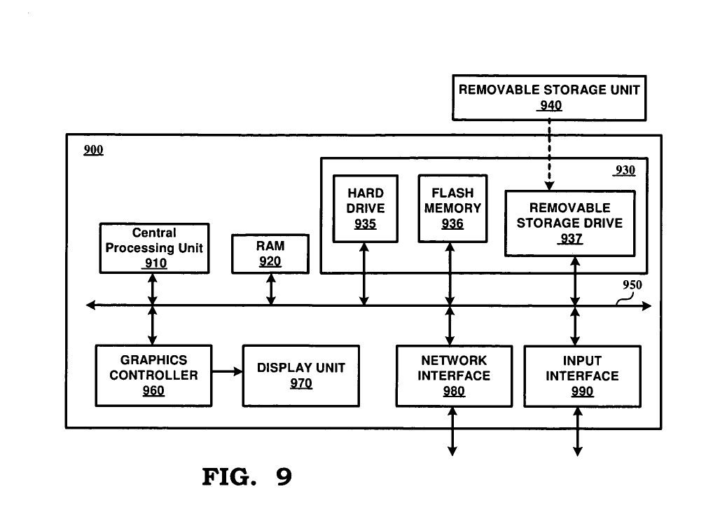

FIG. 9 is a block diagram illustrating the details of digital processing system 900 in which various aspects of the present invention are operative by execution of appropriate software instructions. Digital processing system 900 may correspond to server system 230 or calendar server 254 of FIG. 2. Digital processing system 900 may contain one or more processors (such as a central processing unit (CPU) 910), random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions stored in RAM 920 to provide several features of the present invention. CPU 910 may contain multiple processing units, with each processing unit potentially being designed for a specific task. Alternatively, CPU 910 may contain only a single general purpose-processing unit. RAM 920 may receive instructions from secondary memory 930 using communication path 950

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and a pointing device (e.g., touch-pad, mouse). Network interface 980 provides connectivity to a network (e.g., using Internet Protocol), and may be used to communicate with others connected systems of FIG. 2.

Secondary memory 930 may contain hard drive 935, flash memory 936, and removable storage drive 937. Secondary memory 930 may store the data (e.g., data stored in the repository 232) and software instructions (e.g., implementing the flowcharts of FIGS. 5 to 7), which enable digital processing system 900 to provide several features in accordance with the present invention. Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable storage medium having stored therein computer software and/or data. However, the computer (or in general, machine) readable storage medium can be in other forms (e.g., non-removable, random access, etc.).

Further, even though the machine-readable medium is shown as being contained within digital processing system 900, it should be appreciated that the medium can be provided external to digital processing system 900. In such a case, the instructions may be received, for example, on a network. In addition, some of the aspects can be implemented on a cooperating set of computer systems, even though the digital processing system 900 is shown as a single system. The software instructions may accordingly be adapted for such distributed processing.

In this document, the term “computer program product” is used to generally refer to removable storage unit 940 or hard disk installed in hard drive 935. These computer program products are means for providing software to digital processing system 900. CPU 910 may retrieve the software instructions, and execute the instructions to provide various features of the present invention described above.

However, it should be appreciated that various hardware components are operative when providing the features of the present invention. For example, when one of the systems/devices sends some data (e.g., information to define a group, meeting request, when determining the availability of each member, etc.), the corresponding network interface 980 (hardware) may be operative to send/receive packets. Similarly, various operations such as identifying members of a group (or other identifications), parsing, creating a schedule, storing, determining, etc., may entail CPU 910 to be operative, in addition to data retrieval/storage from corresponding computer readable medium (including registers, not shown). The keyboard, graphics controller and display units are operative when a user provides information using a graphical user interface (GUI).

4. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A method of scheduling a group meeting said method comprising:
receiving from a first user, information to define a group, wherein said group comprises a plurality of members;
storing said information on said group in a repository;
receiving from a second user using a mobile device a meeting request message indicating a request for said group meeting for said group, wherein said second user is a member of said group;
identifying said plurality of members of said group based on said information stored in said repository for said group;
determining from a calendar system the availability of each of said plurality of members; and
creating a schedule for said group meeting.

2. The method of claim 1 wherein, said receiving from said first user, information to define said group comprises:
receiving a group identifier for said group;
receiving information on each of said plurality of members;
setting one or more attributes for each of said plurality of members; and
receiving information on one or more resources required for said group meeting.

3. The method of claim 2 wherein said first user defines said group using a graphical user interface and wherein said information on said group is configurable using said graphical user interface.

4. The method of claim 1 further comprising authentication of said second user.

5. The method of claim 1 wherein, said meeting request message is one of a plurality of pre-defined messages, said meeting request message includes:
a command indicating a request for said group meeting;
a group identifier identifying said group; and
a proposed date and time for said group meeting.

6. The method of claim 5 wherein said meeting request message is a text message in a short messaging service format.

7. The method of claim 5 further comprising, parsing said meeting request message based on said plurality of pre-defined messages and validating said meeting request message.

8. The method of claim 1 wherein, said identifying from said repository comprises:
identifying a user identifier for each of said plurality of members;
identifying one or more attributes for each of said plurality of members; and
identifying one or more resources required for said group meeting.

9. The method of claim 1 wherein said creating comprises:
creating a meeting identifier for said group meeting;
storing said meeting identifier for said group meeting in said repository; and
updating in said calendar system a calendar for each of said plurality of members.

10. The method of claim 1 further comprising sending a meeting schedule message upon said creating to each of said plurality of members wherein, said meeting schedule message is one of a plurality of pre-defined messages sent to a mobile device of each of said plurality of members and wherein said meeting schedule message includes a meeting identifier identifying said group meeting and a scheduled date and time for said group meeting.

11. The method of claim 10 wherein, said plurality of mobile devices of each of said plurality of members is identified from said repository.

12. The method of claim 1 further comprising:
receiving from one of said plurality of members a BUSY message indicating unavailability of said one of said plurality of members; and
determining a critical resource attribute for said one of said plurality of members

13. The method of claim 12 further comprising, declining said group meeting when said determining determines that said one of said plurality of members has said critical resource attribute set to YES.

14. The method of claim 12 further comprising, determining a quorum for said group meeting when said determining determines that said one of said plurality of members has said critical resource attribute set to NO.

15. The method of claim 14 further comprising:
creating said group meeting when said determining said quorum, determines that said quorum is satisfied; and
sending to said second user a message indicating the unavailability of said one of said plurality of members for said group meeting.

16. A machine readable medium storing one or more sequences of instructions for causing a server system to schedule a group meeting wherein execution of said one or more sequences of instructions by one or more processors contained in said server system causes said server system to perform the actions of:
receiving from a first user, information to define a group, wherein said group comprises a plurality of members;
storing said information on said group in a repository;
receiving from a second user using a mobile device a meeting request message indicating a request for said group meeting for said group, wherein said second user is a member of said group;
identifying said plurality of members of said group based on said information stored in said repository for said group;
determining from a calendar system the availability of each of said plurality of members; and
creating a schedule for said group meeting.

17. The machine readable medium of claim 16 wherein, said receiving from said first user, information to define said group comprises:
receiving a group identifier for said group;
receiving information on each of said plurality of members;
setting one or more attributes for each of said plurality of members; and
receiving information on one or more resources required for said group meeting.

18. The machine readable medium of claim 16 wherein, said meeting request message is one of a plurality of pre-defined messages and said meeting request message is a text message in a short messaging service format, said meeting request message includes:
a command indicating a request for said group meeting;
a group identifier identifying said group; and
a proposed date and time for said group meeting.

19. A system for scheduling a group meeting, said system comprising:
a server system comprising:
means for receiving from a first user information to define a group, said group comprising a plurality of members;
a memory for storing said information on said group;
means for receiving from a second user using a mobile device a meeting request message, said meeting request message comprising a request for said group meeting for said group wherein said second user is a member of said group;
means for identifying a plurality of members of said group based on said information stored in said memory;
means for communication with a calendar system said communication comprising sending a request for determining the availability of each of said plurality of members and receiving a response;
means for creating a schedule for said group meeting; and
said calendar system comprising:
means for determining the availability of each of said plurality of members; and
means for communication with said server system said communication comprising receiving a request and sending a response indicating the availability of each of said plurality of members.

20. The system of claim 19 wherein said means for receiving from said first user information to define said group comprises a graphical user interface said graphical user interface comprising:
means for receiving a group identifier for said group;
means for receiving information on each of said plurality of members;
means for setting one or more attributes for each of said plurality of members; and
means for receiving information on one or more resources required for said group meeting.

21. The system of claim 19 further comprising means for storing a plurality of pre-defined messages said meeting request message being one of said plurality of pre-defined messages.

22. The system of claim 21 further comprising means for processing said meeting request message, said means for processing comprising:
means for parsing said meeting request message based on said plurality of pre-defined messages; and
means for validating said meeting request message.

23. The system of claim 19 wherein said communication comprising sending said request further comprises sending to said calendar system information on said group meeting, said information including:
information on each of said plurality of members;
information on one or more resources required for said group meeting; and
a proposed date and time for said group meeting; and
said communication comprising receiving said response further comprises receiving from said calendar system information indicating availability of each of said plurality of members and of said one or more resources required for said group meeting.

24. The system of claim 23 further capable of declining said group meeting when said response indicates the unavailability of one or more of said plurality of members and said one or more resources.

25. A method of scheduling a group meeting, said method comprising:
receiving from a first user of a first mobile device, information to define a group, wherein said group comprises a plurality of members;
storing said information on said group in a repository;
receiving from a second user using a second mobile device a meeting request message indicating a request for said group meeting for said group, wherein said second user is a member of said group and wherein said meeting request message is in a short messaging service format and includes a group identifier for said group;
identifying said plurality of members of said group based on said information stored in said repository for said group;
determining from a calendar system the availability of each of said plurality of members; and
creating a schedule for said group meeting when a quorum is met or all critical users are available or a combination thereof.
